(19) United States
(12) Patent Application Publication
(10) Pub. No.: US 2026/0017193 A1
(43) Pub. Date: Jan. 15, 2026

(54) METHOD AND APPARATUS FOR NON-VOLATILE MEMORY MANAGEMENT USING OUT OF BAND (OOB) PATH

(71) Applicant: Samsung Electronics Co., Ltd., Suwon-si (KR)

(72) Inventors: Elavarasan KAMARAJ, Bengaluru (IN); Arun Bosco J, Bengaluru (IN); Karthik BALAN, Bengaluru (IN)

(73) Assignee: Samsung Electronics Co., Ltd., Suwon-si (KR)

(21) Appl. No.: 18/829,684

(22) Filed: Sep. 10, 2024

(30) Foreign Application Priority Data
Jul. 15, 2024 (IN) 202441053889

(51) Int. Cl. G06F 12/02

(52) U.S. Cl. CPC G06F 12/0253; G06F 2212/7205

(57) ABSTRACT

Various example embodiments of the inventive concepts relate to methods for non-volatile memory management using Out Of Band (OOB) path. The method may include monitoring, by processing circuitry associated with a host device, an available spare memory percentage of a non-volatile memory included in a storage device, the storage device communicatively connected to the host device, via the OOB path between the host device and the storage device, determining, by the processing circuitry, a trigger point to initiate a preemptive Garbage Collection (GC) process in the non-volatile memory based on the available spare memory percentage, and transmitting, by the processing circuitry, via the OOB path to the storage device, a command to initiate the preemptive GC process based on the determined trigger point.

### CROSS-REFERENCE TO RELATED APPLICATION

This application is based on and claims the benefit of priority under 35 U.S.C. §119 to Indian Patent Application No. 202441053889, filed on Jul. 15, 2024, in the Indian Intellectual Property Office, the disclosure of which is incorporated by reference herein in its entirety.

### BACKGROUND

Various example embodiments of the inventive concepts relate to storage devices. Particularly, one or more of the example embodiments of the inventive concepts relate to a method, system, and/or apparatus for non-volatile memory management using Out Of Band (OOB) path.

A Garbage Collection (GC) process is performed in memory devices to reallocate the dead memory blocks/memory blocks (e.g., previously allocated memory blocks, etc.) which store data but are not currently in use, so that the memory blocks may be re-used to store new data. The dead memory blocks are the memory blocks that are not used for a long duration. In current (e.g., conventional) implementations of memory management, the GC process is initiated at different levels of spare block thresholds. For instance, the conventional GC process is initiated only when an urgent GC scenario is reached, which affects the Input/Output (I/O) path (e.g., I/O bus) operations of the memory device.

The information disclosed in this background of the disclosure section is only for enhancement of understanding of the general background of the inventive concepts and should not be taken as an acknowledgement or any form of suggestion that this information forms the prior art already known to a person of ordinary skill in the art.

### SUMMARY

Various example embodiments are directed to a method of performing non-volatile memory management using an Out Of Band (OOB) path, an apparatus, a system, and/or a non-transitory computer readable medium thereof. The method comprises monitoring, by processing circuitry associated with a host device, an available spare memory percentage of a non-volatile memory included in a storage device, the storage device communicatively connected to the host device, via the OOB path between the host device and the storage device, the OOB path being separate from an input/output (I/O) path between the host device and the storage device, determining, by the processing circuitry, a trigger point to initiate a preemptive Garbage Collection (GC) process in the non-volatile memory based on the available spare memory percentage, and transmitting, by the processing circuitry, via the OOB path to the storage device, a command to initiate the preemptive GC process based on the determined trigger point, the command causing the storage device to execute the preemptive GC process on the non-volatile memory upon receipt.

Further, at least one example embodiment of the inventive concepts relates to a host device for non-volatile memory management using an Out Of Band (OOB) path. The host device comprises a memory having computer readable instructions stored thereon, and processing circuitry configured to execute the computer readable instructions to cause the host device to, monitor an available spare memory percentage of a non-volatile memory included in a storage device communicatively connected to the host device via the OOB path separate from an input/output (I/O) path between the host device and the storage device, determine a trigger point to initiate a preemptive Garbage Collection (GC) process in the non-volatile memory based on the available spare memory percentage, and transmit via the OOB path to the storage device, a command to initiate the preemptive GC process based on the determined trigger point, the command causing the storage device to execute the preemptive GC process on the non-volatile memory.

The foregoing summary is illustrative only and is not intended to be in any way limiting. In addition to the illustrative aspects, example embodiments, and/or features described above, further aspects, example embodiments, and/or features will become apparent by reference to the drawings and the following detailed description.

### BRIEF DESCRIPTION OF THE DRAWINGS

The accompanying drawings illustrate example embodiments and, together with the description, explain the disclosed principles. In the figures, the left-most digit(s) of a reference number identifies the figure in which the reference number first appears. The same numbers are used throughout the figures to reference like features and components. Some example embodiments of systems, apparatuses, and/or methods in accordance with example embodiments of the inventive concepts are now described, by way of example only, and regarding the accompanying figures, in which:

FIG. 1A shows an illustration of communication between a host device and a storage device, in accordance with some example embodiments of the inventive concepts;

FIG. 1B shows an example illustration of communication between a host device and a storage device via Input/Output (I/O) path and Out Of Band (OOB) path, in accordance with some example embodiments of the inventive concepts;

FIG. 2A shows a detailed block diagram of a host device, in accordance with some example embodiments of the inventive concepts;

FIG. 2B shows an example flowchart illustrating non-volatile memory management using an OOB path, in accordance with some example embodiments of the inventive concepts;

FIG. 3 shows a flowchart illustrating a method of non-volatile memory management using an OOB path, in accordance with some example embodiments of the inventive concepts;

FIG. 4A shows an example graph illustrating an impact of non-volatile memory management using an OOB path, in accordance with some example embodiments of the inventive concepts;

FIG. 4B shows an example graph illustrating a trend in available spare memory percentage, in accordance with some example embodiments of the inventive concepts; and

FIG. 5 illustrates a general computer system architecture, in accordance with some example embodiments of the inventive concepts.

It should be appreciated by those skilled in the art that any block diagrams herein represent conceptual views of illustrative systems embodying the principles of one or more of the example embodiments. Similarly, it will be appreciated that any flow charts, flow diagrams, state transition diagrams, pseudo code, and the like represent various processes which may be substantially represented in computer readable medium and executed by a computer and/or processor, whether such computer and/or processor is explicitly shown.

### DETAILED DESCRIPTION

In some aspects, an urgent GC process (also known as a forced GC, etc.) may be performed in response to no memory block being available for performing memory operations and the storage device may reclaim the un-used memory blocks and/or dead memory blocks to perform the memory operations. Due to continuous workload, a Flash Translation Layer (FTL) may not initiate the GC process until the urgent GC scenario is reached. During the urgent GC scenario, the FTL may block the I/O path from performing GC process which may cause degradation in the performance of the memory device. Due to the blocking of the I/O path, the memory device cannot perform I/O operations which may degrade the performance of the memory device until the urgent GC process is completed. Moreover, in some examples, data blocks may be identified as valid data blocks and invalid data blocks.

In some aspects, TRIM commands may be issued to free-up the space (e.g., perform garbage collection) by deleting the allocation of the invalid data blocks. However, the I/O path may be affected by the execution of the trim commands. In some example embodiments, a GC process may be configured not to affect the I/O path and without degrading the performance of the memory device.

While the example embodiments discussed herein are susceptible to various modifications and alternative forms, specific example embodiments thereof have been shown by way of example in the drawings and will be described in detail below. It should be understood, however, that it is not intended to limit the example embodiments to the specific forms disclosed, but on the contrary, the example embodiments cover all modifications, equivalents, and alternative falling within the scope of the inventive concepts.

The terms “comprises”, “comprising”, “includes”, or any other variations thereof, are intended to cover a non-exclusive inclusion, such that a system, device, and/or method that comprises a list of components or operations does not include only those components or operations but may include other components and/or operations not expressly listed or inherent to such system, device, and/or method. In other words, one or more elements in a system or apparatus proceeded by “comprises . . . a” does not, without more constraints, preclude the existence of other elements or additional elements in the system, device, and/or method, etc.

In some aspects, the technical problems relate to degradation in the performance of a memory device when a Garbage Collection (GC) process is not initiated even after a desired and/or predefined threshold is reached, which causes an urgent GC scenario and/or urgent GC process, etc. During the urgent GC process, the Input/Output (I/O) path (e.g., I/O bus, I/O bus channel, etc.) is blocked in order to perform the urgent GC process, which causes the blocking (and/or halting, etc.) of non-GC I/O operations. Hence, one or more of the example embodiments of the inventive concepts provide a method of non-volatile memory management using an Out Of Band (OOB) path, OOB bus, and/or OOB channel, etc. The OOB path is a path (e.g., channel, bus, etc.) which is different and/or separate from the I/O path. According to at least one example embodiment of the inventive concepts, a controller associated with a host device monitors an available spare memory percentage of a non-volatile memory included in a storage device communicatively connected to the host device, e.g., in real-time and/or near-real-time, etc., via the OOB path, but is not limited thereto. The available spare memory percentage may indicate a percentage and/or a total amount of available memory blocks (e.g., free memory blocks, etc.) in the non-volatile memory of the storage device. Upon monitoring the available spare memory percentage (and/or the total amount of available memory blocks, etc.), the controller determines whether a trigger point has been reached and/or exceeded, and if the trigger point has been reached and/or exceeded, to initiate a preemptive non-urgent, and/or non-forced GC process in the non-volatile memory based on the available spare memory percentage (and/or the total amount of spare memory, etc.). A value of the trigger point for initiating the preemptive GC process is different from a value for initiating the urgent GC process. Finally, the controller transmits via the OOB path, which is different from an I/O path, a command to initiate the GC process upon determining the trigger point has been met and/or exceeded. The GC process (e.g., preemptive GC process, etc.) is executed upon receipt of the command to manage the non-volatile memory. The controller does not wait until the urgent GC scenario is reached, and the controller initiates the GC process (e.g., preemptive GC process, etc.) prior to the urgent GC scenario. Hereinafter, the preemptive GC process will be referred to as a GC process (or GC operation).

In at least one example embodiment, at least one example embodiment determines a trigger point to initiate a GC process and a value of a trigger point for the GC process is different than the value to initiate an urgent GC process. This helps in mitigating the blocking of the I/O path, which occurs during the performance of a conventional urgent GC process. This also helps in decreasing and/or preventing memory devices from entering a critical state and/or undesired state where no I/O operations can be performed because the I/O path is blocked during the performance of the urgent GC operation. At least one example embodiment utilizes an OOB path to monitor the available spare memory percentage and transmit the command to initiate a GC process. This helps in reducing the latency of I/O operations because the OOB path is different and/or separate from the I/O path and the I/O path is not affected during the performance of the GC process. This also helps in mitigating and/or decreasing the critical state and/or undesired state due to the I/O path not being affected by the performance of the GC process. The memory device performs the memory operations (e.g., I/O operations) without any interruption due to the initiation of the GC process.

In the following detailed description of one or more of the example embodiments of the disclosure, reference is made to the accompanying drawings that form a part hereof, and in which are shown by way of illustration specific example embodiments in which the disclosure may be practiced. These example embodiments are described in sufficient detail to enable those skilled in the art to practice the disclosure, and it is to be understood that other example embodiments may be utilized and that changes may be made without departing from the scope of the inventive concepts. The following description is, therefore, not to be taken in a limiting sense.

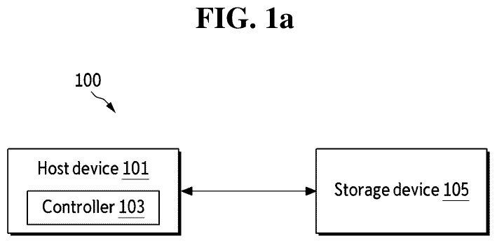

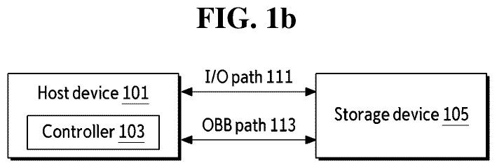

FIG. 1A shows an illustration of communication between a host device and a storage device, in accordance with some example embodiments of the inventive concepts.

Example system 100 comprises at least one apparatus which may be a host device 101 which may be communicatively connected to at least one storage device 105 (also referred as non-volatile memory, etc.). In at least one example embodiment, the host device 101 may comprise a controller 103 (e.g., processing circuitry, processor, etc.) configured for non-volatile memory management using an OOB path. As an example, the host device 101 may be, without limitation, a mobile device, such as a portable communication terminal (e.g., a mobile phone), a smartphone, a tablet, a Personal Computer (PC), a wearable device, an Internet of Things (IoT) device, and/or a laptop computer, etc., but is not limited thereto. As an example, the controller 103 may be a Baseboard Management Controller (BMC), etc., but is not limited thereto. In at least one example embodiment, an existing controller 103 and/or a processor of the host device 101 may be configured to perform non-volatile memory management using the OOB path. In some example embodiments, the controller 103 and the processor of the host device may be combined into a single processing device, etc. In at least one example embodiment, the host device 101 may be connected to at least one storage device 105 via at least one Input/Output (I/O) path and the OOB path 113 (as shown in FIG. 1B). In at least one example embodiment, the storage device 105 may be a non-volatile storage device such as Solid-State Devices (SSDs), memory cards, a Universal Flash Storage (UFS), an embedded Multi-Media Card (cMMC), a Non-Volatile Memory express (NVMe) based devices, and the like. An Input/Output (I/O) path 111 may be used for performing the input/output operations between the host device 101 and the storage device 105. The OOB path (e.g., OOB bus, OOB bus channel, etc.) 113 may be a path (e.g., a bus, a bus channel, etc.) different from the I/O path 111 (e.g., I/O bus, I/O bus channel, etc.) which may be used by the controller 103 to communicate with the storage device 105 and vice-versa, for performing specific functionalities and/or operations related to Garbage Collection (GC), or in other words, the OOB path may be a path dedicated to GC. According to at least one example embodiment, the controller 103 may be implemented as processing circuitry and may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

In at least one example embodiment, the controller 103 of the host device 101 may monitor the available spare memory percentage in a non-volatile memory of the storage device 105 communicatively connected to the host device 101 in real-time and/or near-real-time via the OOB path 113, but the example embodiments are not limited thereto, and for example, the host device 101 may monitor a total amount of spare memory in the non-volatile memory of the storage device 105 instead of, or in addition to, the percentage of available spare memory, etc. The available spare memory percentage may indicate the percentage of memory blocks available in the storage device 105 to store data. For instance, if the available spare memory percentage is 50%, then 50% of memory blocks are available (e.g., free, unallocated, etc.) to store data in the storage device 105. In at least one example embodiment, the available spare memory percentage is monitored via the OOB path 113 which is a different and/or separate path than the I/O path 111. In at least one example embodiment, the available spare memory percentage may be updated in a dedicated field configured in a memory management data structure, but the example embodiments are not limited thereto. As an example, Flash Translation Layer (FTL) of Firmware (FW) may be configured to update a vendor specific field “command code 202” (Available Spare Memory Percentage), etc. The “command code 202” of the memory management data structure may be updated with the available spare memory percentage.

In at least one example embodiment, upon monitoring the available spare memory percentage via the OOB path 113, the controller 103 may determine a trigger point has been reached to initiate a Garbage Collection (GC) process (e.g., a GC operation, etc.) in the non-volatile memory based on the available spare memory percentage (and/or a total available memory threshold value). When the memory blocks are not used for a desired and/or predefined duration, then the memory blocks are identified as dead memory blocks. The GC process may be performed in the non-volatile memory to reallocate the dead memory blocks which may be re-used to store the data. In at least one example embodiment, a value of the trigger point for initiating the GC process is different from a value for initiating the urgent GC process, and for example, the value of the GC process trigger point may be lower than the value of the urgent GC process trigger point, etc. The urgent GC process (also known as a forced GC process, etc.) may be performed when insufficient memory blocks are available for performing one or more desired memory operations (e.g., I/O operations), such as a storage operation (e.g., a write operation, etc.) and the storage device 105 has to reclaim the un-used allocated memory blocks and/or dead memory blocks to perform the memory operations (e.g., I/O operations). Performing urgent GC operations may cause degradation in the performance of the storage device 105 due to the I/O path and/or I/O bus of the storage device 105 being used for the urgent GC operation instead of performing scheduled I/O operations, etc. In at least one example embodiment, the trigger point to initiate the GC is different from the value for initiating the urgent GC process to avoid the urgent GC and degradation in the performance of the memory device. Consider an example scenario in which the available spare memory percentage has four levels (e.g., L1 to L4), wherein each level indicates the available spare memory percentage, but the example embodiments are not limited thereto. The level L4 may be the threshold to initiate the urgent GC process. In at least one example embodiment, the trigger point may be a point determined by the controller 103 which indicates the trigger to initiate the GC process, in view of a downward trend of the available spare memory percentage, such that, the GC process is completed in advance, before a critical state and/or undesired state of the available memory (e.g., the trigger point for the urgent GC process) is reached where no free memory blocks are available for storing data. Considering the above example, where available spare memory percentage is defined in four levels, the trigger point for triggering a GC process may be set to level L3 which is different from a value for initiating the urgent GC process e.g., level L4. In at least one example embodiment, if the available spare memory has reached the desired and/or predefined threshold level, the controller 103 may determine whether the available spare memory percentage is showcasing a downward trend (e.g., a decreasing available memory percentage, etc.) based on the monitoring and/or real-time monitoring of the available spare memory. The downward trend may indicate that the available spare memory percentage is decreasing which means the available memory blocks are decreasing and/or decreasing gradually in the memory device for storage, after reaching the desired and/or predefined threshold level corresponding to the GC. If the available spare memory percentage showcases the downward trend, the controller 103 determines the trigger point has been met e.g., the controller 103 infers that it is time to trigger the GC process. However, if the available spare memory percentage showcases an upward trend and/or a stable trend (e.g., the available memory percentage is increasing and/or is stable, etc.), the controller 103 determines that the available spare memory is increasing and/or is stable and hence, the next scheduled I/O command is processed and/or executed using the I/O path (and not the OOB path) without initiating the GC process.

In at least one example embodiment, upon determining the trigger point to initiate GC process, the controller 103 may be configured to transmit via the OOB path 113 different from an I/O path 111, a command to the storage device 105 to initiate the GC process. The GC process is executed by the storage device 105 upon receipt of the command to manage the non-volatile memory. In some example embodiments, the command to initiate the GC process may be a Vendor Unique Command (VUC), but the example embodiments are not limited thereto. The VUC may be a command that is specific to a vendor and/or manufacturer of the memory device, but is not limited thereto. The VUC of the memory device may vary based on the vendors of the memory device. In some example embodiments, the command to initiate the GC process may be a general command and/or global command and may not be vendor specific. As explained above, the GC process may be initiated without waiting until the urgent GC threshold has been met. Upon receiving the command to initiate the GC process, the memory device may perform the GC process, which in turn increases the available spare memory percentage without halting the memory operations performed via the I/O path 111. In at least one example embodiment, the available spare memory percentage may be updated in real-time and/or near-real-time upon performing the GC process, but the example embodiments are not limited thereto.

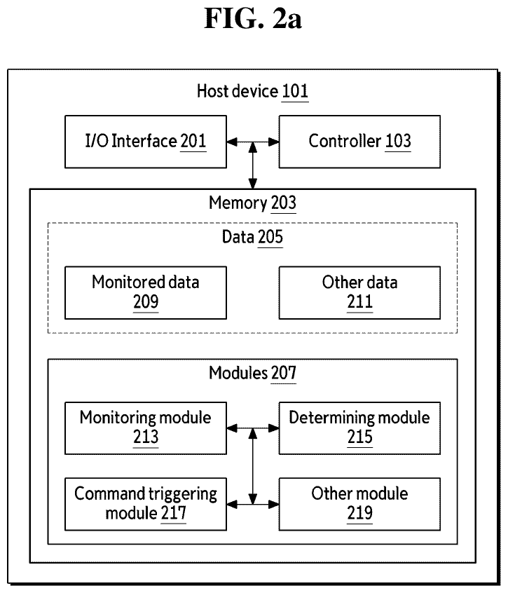

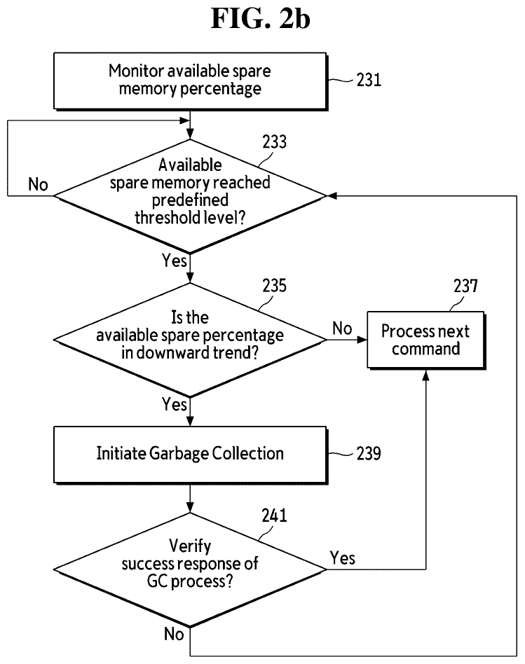

FIG. 2A shows a detailed block diagram of a host device 101, in accordance with some example embodiments of the inventive concepts.

In some example embodiments, the host device 101 may include an I/O interface 201, at least one controller 103 (e.g., processing circuitry, processor, etc.) and/or at least one memory 203 (e.g., at least one memory device, etc.), but the example embodiments are not limited thereto, and for example, the host device 101 may include a greater or lesser number of constituent components. In at least one example embodiment, the memory 203 may be communicatively coupled to the controller 103. The controller 103 may be configured to perform one or more special purpose functions and/or operations for non-volatile memory management using an OOB path, using the data 205 and/or the one or more modules 207 (e.g., software modules, software applications, programs, computer readable instructions, etc.) of the host device 101. In at least one example embodiment, the memory 203 may store data 205.

In at least one example embodiment, the data 205 stored in the memory 203 may include, without limitation, monitored data 209 and other data 211. In some example embodiments, the data 205 may be stored within the memory 203 in the form of various data structures. Additionally, the data 205 may be organized using data models, such as relational and/or hierarchical data models, etc., but is not limited thereto. The other data 211 may include various temporary data and/or files generated by the one or more modules 207.

In at least one example embodiment, the monitored data 209 may store the information related to the available spare memory percentage in a non-volatile memory of a memory device. In at least one example embodiment, the monitored data 209 may be updated in real-time and/or near-real-time, but is not limited thereto, and for example the data may be monitored by the host device 101 on demand, dynamically, and/or at desired time intervals. The monitored data 209 may be updated in a dedicated field configured in a memory management data structure. As an example, Flash Translation Layer (FTL) of Firmware (FW) may be configured to update a vendor specific field “command code 202” (e.g., Available Spare Memory Percentage), but is not limited thereto. In at least one example embodiment, the monitored data 209 may be used to determine a trigger point for a Garbage Collection (GC) process and/or operation in the non-volatile memory of the memory device. As an example, when the monitored data 209 may indicate that the available spare memory percentage is decreasing after reaching a desired and/or predefined threshold level corresponding to the GC process, the controller 103 may initiate and/or begin a GC process and/or operation.

In at least one example embodiment, the data 205 may be processed by the one or more modules 207 of the host device 101. In some example embodiments, the one or more modules 207 may be communicatively coupled to the controller 103 for performing one or more functions of the host device 101. In at least one example embodiment, the one or more modules 207 may include, without limiting to, a monitoring module 213, a determining module 215, a command triggering module 217, and/or other modules 219, etc., but is not limited thereto. According to at least one example embodiment, one or more of the modules 207, e.g., monitoring module 213, determining module 215, command triggering module 217, and/or the other modules 219, etc., may be implemented as processing circuitry and may include hardware or hardware circuit including logic circuits; a hardware/software combination such as a processor executing software and/or firmware; or a combination thereof.

For example, the term module may refer to an Application Specific Integrated Circuit (ASIC), an electronic circuit, a hardware processor (e.g., shared, dedicated, and/or group, etc.) and memory that execute one or more special purpose software and/or firmware programs, a combinational logic circuit, and/or other suitable components that provide the described functionality. In at least one example embodiment, each of the one or more modules 207 may be configured as stand-alone special purpose hardware computing units, but the example embodiments are not limited thereto, and instead the modules of 207 may be included in the controller 103, processing circuitry, and/or at least one processor included in the host device 101, etc. In at least one example embodiment, the other modules 219 may be used to perform various miscellaneous functionalities on the host device 101. It will be appreciated that such one or more modules 207 may be represented as a single module or a combination of different modules.

In at least one example embodiment, the monitoring module 213 may be configured for monitoring available spare memory percentage in a non-volatile memory of a storage device 105 communicatively connected to the host device 101 in real-time (and/or near-real-time, substantially real-time, etc.) via an OOB path. The available spare memory percentage information may be updated in real-time (and/or near-real-time, substantially real-time, etc.), in a dedicated field configured in a memory management data structure, but the example embodiments are not limited thereto, and for example, the available spare memory percentage information may be determined on demand, at desired time intervals, etc. Referring to FIG. 2B, at operation 231, the monitoring module 213 monitors the available spare memory percentage of the storage device 105. However, the example embodiments are not limited thereto, and for example, a total amount of spare memory may be determined and monitored instead of the available spare memory percentage, etc.

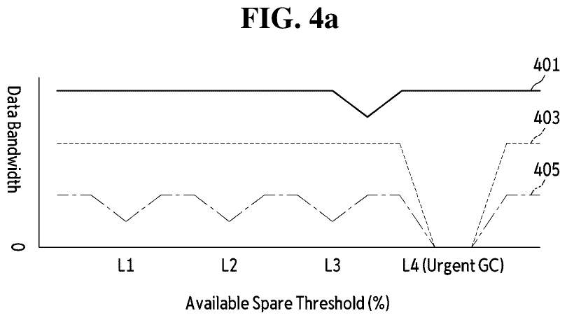

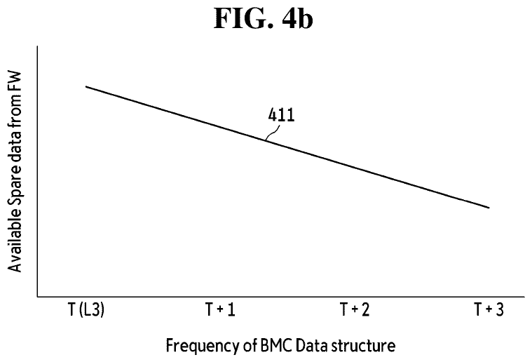

In at least one example embodiment, the determining module 215 may be configured to determine a trigger point to initiate Garbage Collection (GC) process in the non-volatile memory based on available spare memory percentage. In at least one example embodiment, the trigger point is a point in time determined by the determining module 215 which indicates that a command to initiate the GC process should be transmitted to the storage device 105, in view of and/or based on a determined downward trend of the available spare memory percentage (and/or a downward trend of the total amount of spare memory), such that, the GC process is completed in advance, before a critical state and/or undesired state is reached where no free memory blocks are available for storing data. Therefore, clearly, a value of the trigger point for initiating the GC process is different from a value for initiating the urgent GC process. Referring to FIG. 2B, at operation 233, the determining module 215 may determine whether the available spare memory percentage indicates that the available spare memory has reached a desired and/or predefined threshold level corresponding to the GC. At operation 235, if the available spare memory has reached the desired and/or predefined threshold level, the determining module 215 may determine whether the available spare memory percentage is showcasing a downward trend based on the real-time monitoring of the available spare memory. The downward trend may indicate that the available spare memory percentage is decreasing which means the available memory blocks are decreasing gradually in the memory device for storage, after reaching the desired and/or predefined threshold level corresponding to the GC. If the available spare memory percentage showcases the downward trend (as shown in FIG. 4B), the determining module 215 determines the trigger point, e.g., the determining module 215 infers that it is time to trigger the GC process. However, if the available spare memory percentage showcases an upward trend, at operation 237, the determining module 215 determines that the available spare memory is increasing, and the next I/O command is processed and/or executed using the I/O path (and not the OOB path) without initiating the GC process.

In at least one example embodiment, the command triggering module 217 may be configured to transmit via the OOB path 113, which is different and/or separate from the I/O path 111, a command to the storage device 105 to initiate the GC process upon determining and/or detecting the trigger point has been reached. The GC process is executed by the storage device 105 upon receipt of the command to manage the non-volatile memory. Referring to FIG. 2B, at operation 239, the GC process is initiated by the storage device 105 upon receiving the GC command from the command triggering module 217 via the OOB path 113, but is not limited thereto. At operation 241, the success of the GC process is determined, and if the GC process is successfully performed, the next I/O command (e.g., memory command, etc.) is processed and/or executed using the I/O path, and not the OOB path. If the GC process is not successfully performed, the process returns to operation 233, e.g., determining whether the available spare memory percentage (and/or the total amount of spare memory, etc.) indicates that the available spare memory has reached a desired and/or predefined threshold level corresponding to performing a GC process and/or operation.

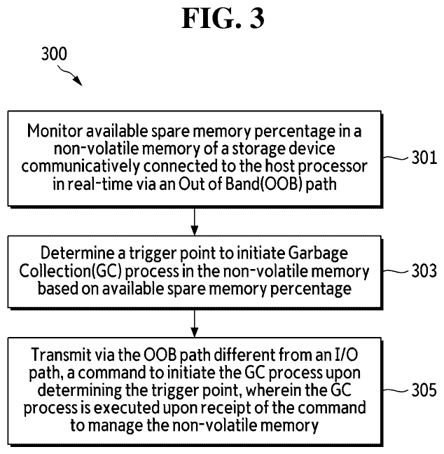

FIG. 3 shows a flowchart illustrating a method of performing non-volatile memory management using an OOB path, in accordance with some example embodiments of the inventive concepts.

The method 300 may be performed using the controller 103 configured in host device 101 illustrated in FIG. 2A, but the example embodiments are not limited thereto, and for example, a different computing device may be used to perform the operations of the method 300. The method 300 may be described in the context of computer executable instructions specially programmed to perform the method 300. Generally, computer executable instructions may include routines, programs, objects, components, data structures, procedures, modules, and/or functions, etc., which perform specific functions or implement specific abstract data types.

The order in which the method 300 is described is not intended to be construed as a limitation, and any number of the described method operations may be combined in any order to implement the method. Additionally, individual operations may be deleted from the method without departing from the scope of the example embodiments of the inventive concepts described herein. Furthermore, the method may be implemented in any suitable hardware, or combination of hardware executing software and/or firmware.

At operation 301, the method 300 includes monitoring, by a controller 103 of the Host device 101, available spare memory percentage (and/or total available spare memory) in a non-volatile memory of a storage device 105 communicatively connected to the host device 101 in real-time (and/or substantially real-time, near real-time, etc.) via an OOB path.

At operation 303, the method 300 includes determining, by the controller 103, a trigger point to initiate Garbage Collection (GC) process in the non-volatile memory based on available spare memory percentage, or in other words, determining whether a trigger point has been reached and/or exceeded for initiating a GC operation based on the available spare memory percentage (and/or based on the total available spare memory, etc.). A value of the trigger point for initiating the GC process may be different from (e.g., less than) a value for initiating the urgent GC process. According to at least one example embodiment, the value of the trigger point may be considered a GC threshold value.

At operation 305, the method 300 includes transmitting, by the controller 103, via the OOB path 113 different and/or separate from an I/O path 111, a command to the storage device 105 to initiate the GC process upon determining the trigger point, or in other words the controller 103 may transmit a GC initiation command to the storage device 105 via the OOB path 113 based on the available spare memory percentage and a GC threshold value. The GC process is executed by the storage device 105 upon receipt of the command to manage the non-volatile memory. The command to initiate the GC process is a Vendor Unique Command, but is not limited thereto.

FIG. 4A shows an example graph illustrating an impact of non-volatile memory management using an OOB path, in accordance with some example embodiments of the inventive concepts.

The “X” axis in the example graph illustrates a plurality of levels of available spare memory percentage L1-L4, but the example embodiments are not limited thereto. The level L4 may be a threshold level corresponding to an urgent Garbage Collection (GC) scenario. The controller 103 initiates the GC process prior to the urgent GC scenario which is shown using the line 401. The memory bandwidth (e.g., I/O bandwidth, etc.) affected is very small when compared to an existing/conventional approach in which the GC process is initiated only during the urgent GC scenario. The lines 403 and 405 illustrate the existing/conventional approach, in which the data bandwidth is affected due to the I/O path being affected and/or blocked when a conventional GC operation is performed.

FIG. 4B shows an example graph illustrating a trend in available spare memory percentage, in accordance with some example embodiments of the inventive concepts.

In at least one example embodiment, as shown in the graph, when available spare memory has reached the desired and/or predefined threshold level, e.g., L3 as show in FIG. 4B, the controller 103 may determine whether the available spare memory percentage is showcasing a downward trend based on the real-time monitoring of the available spare memory. The downward trend may indicate that the available spare memory percentage is decreasing which means that the available memory blocks for storage are decreasing gradually in the memory device, after reaching the desired and/or predefined threshold level corresponding to the GC level. If the available spare memory percentage showcases the downward trend, the controller 103 determines that the trigger point has been met and/or exceeded, e.g., the controller 103 infers that it is time to trigger the GC process and the GC process is initiated.

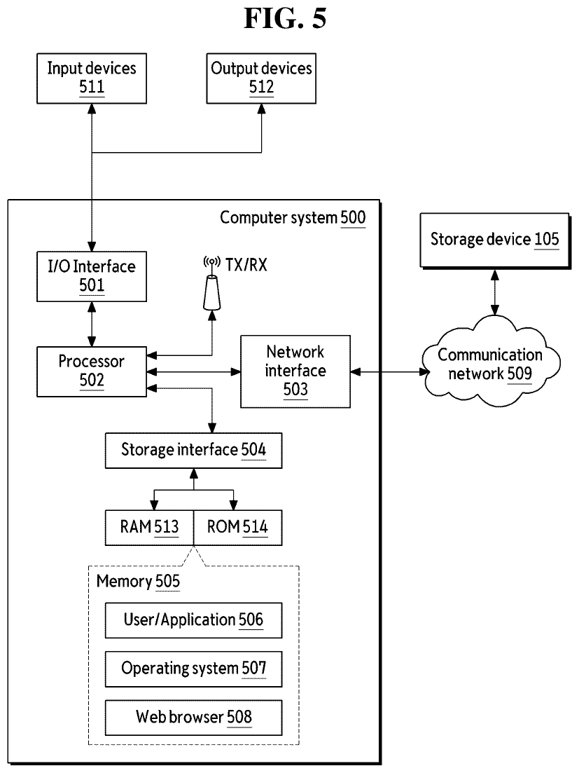

FIG. 5 illustrates a block diagram of an example computer system 500 for implementing one or more example embodiments of the inventive concepts. In at least one example embodiment, the computer system 500 may be the host device 101 illustrated in FIG. 1A, but is not limited thereto. The computer system 500 may include a central processing unit (“CPU,” “processor,” “processing circuitry,” and/or “memory controller”, etc.) 502. The processor 502 may comprise at least one data processor for executing program components for executing user-and/or system-generated business processes. A user may include a network manager, an application developer, a programmer, an organization or any system/sub-system being operated in parallel to the computer system 500. The processor 502 may include specialized processing units such as integrated system (bus) controllers, memory controllers/memory management control units, floating point units, graphics processing units, digital signal processing units, etc.

The processor 502 may communicate with one or more Input/Output (I/O) devices (e.g., I/O devices 511 and 512) via at least one I/O path (e.g., I/O channel, I/O bus, etc.) connected to at least one I/O interface 501, but is not limited thereto. The I/O interface 501 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the at least one I/O interface 501, the computer system 500 may communicate with one or more I/O devices, e.g., I/O devices 511 and 512, etc.

In some example embodiments, the processor 502 may communicate with at least one network 107 via at least one network interface 503. The network interface 503 may communicate with the network 509. The network interface 503 may employ connection protocols including, without limitation, direct connect, Ethernet (e.g., twisted pair 10/100/1000 Base T), Transmission Control Protocol/Internet Protocol (TCP/IP), token ring, IEEE® 802.11a/b/g/n/x, etc.

In at least one example embodiment, the network 509 may be implemented as one of the several types of networks, such as intranet or Local Area Network (LAN) and such within the organization. The network 509 may be a dedicated network and/or a shared network, which represents an association of several types of networks that may use a variety of protocols, for example, Hypertext Transfer Protocol (HTTP), Transmission Control Protocol/Internet Protocol (TCP/IP), Wireless Application Protocol (WAP) etc., to communicate with each other. Further, the network 509 may include a variety of network devices, including routers, bridges, servers, computing devices, storage devices, etc. Using the network interface 503 and the network 509, the computer system 500 may communicate with at least one storage device 105. The storage device 105 may be a non-volatile storage device, such as Solid-State Devices (SSDs), memory cards, a Universal Flash Storage (UFS), an embedded Multi-Media Card (cMMC), a Non-Volatile Memory express (NVMe) based devices, and the like.

In some example embodiments, the processor 502 may communicate with a memory 505 (e.g., RAM 513, ROM 514, etc. as shown in FIG. 5) via at least one storage interface 504, but the example embodiments are not limited thereto. The storage interface 504 may connect to memory 505 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program and/or database components, including, without limitation, user/application interface 506, an operating system 507, a web browser 508, and the like. In some example embodiments, computer system 500 may store special purpose user/application data 506, such as the data, variables, records, etc. for implementing one or more of the example embodiments of the inventive concepts. Examples of databases which may be implemented as fault-tolerant, relational, scalable, secure databases such as Oracle®, Sybase®, and/or PostgreSQL®, but the example embodiments are not limited thereto.

The operating system 507 may facilitate resource management and/or operation of the computer system 500. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HATO, UBUNTU@, KUBUNTU@, etc.), IBM OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 506 may facilitate display, execution, interaction, manipulation, and/or operation of program components through textual and/or graphical facilities. For example, the user interface 506 may provide computer interaction interface elements on a display system operatively connected to the computer system 500, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., Acro, Metro, etc.), web interface libraries (e.g., ActiveX®, JAVA®, JAVASCRIPT®), AJAX, HTML, ADOBE® FLASH®, etc.), or the like.

The web browser 508 may be a hypertext viewing application. Secure web browsing may be provided using Secure Hypertext Transport Protocol (HTTPS), Secure Sockets Layer (SSL), Transport Layer Security (TLS), and the like. The web browsers 508 may utilize facilities such as AJAX, DHTML, ADOBE® FLASH®, JAVASCRIPT®, JAVA®, Application Programming Interfaces (APIs), and the like. Further, the computer system 500 may implement a mail server stored program component. The mail server may utilize facilities such as ASP, ACTIVEX®, ANSI® C++/C#, MICROSOFT®,.NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some example embodiments, the computer system 500 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more non-transitory computer-readable storage media may be utilized in implementing one or more example embodiments of the inventive concepts. A non-transitory computer-readable storage medium refers to any type of physical memory on which information and/or data readable by at least one processor may be stored. Thus, a non-transitory computer-readable storage medium may store special purpose computer readable instructions for execution by one or more processors, including special purpose computer readable instructions for causing the processor(s) to perform operations included in one or more of the example embodiments described herein. The term “computer-readable medium” should be understood to include tangible items and exclude carrier waves and transient signals, e.g., the computer-readable medium is a non-transitory computer-readable medium. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

In at least one example embodiment, the proposed method determines a trigger point to initiate a preemptive GC process, where the value of the preemptive GC process trigger point is different from the value to initiate an urgent GC process. This helps in mitigating the blocking of the I/O path, because the I/O path is blocked during the performance of an urgent GC process, or in other words, the efficiency of the I/O bus is increased and/or improved by the example embodiments of the inventive concepts. This also helps in decreasing and/or preventing memory devices from entering a critical state where no I/O operations can be performed due to the I/O path being blocked during the performance of an urgent GC operation.

The proposed method utilizes at least one OOB path to monitor the available spare memory percentage and transmit the command to initiate the GC process. This helps in reducing the latency of I/O operations as the OOB path is different from and separate from the I/O path, and the I/O path is not affected by the GC process, or in other words the I/O path is not halted during the GC process because the GC process is performed using the OOB path, thereby allowing the memory device to perform the memory operations (e.g., I/O operations) using the I/O path without any interruption due to the initiation and/or performance of a GC process.

As stated above, it shall be noted that the method of one or more example embodiments of the inventive concepts may be used to overcome various technical problems related to non-volatile memory management. In other words, the disclosed method has a practical application and provides a technically advanced solution to the technical problems associated with the existing approach in non-volatile memory management.

In light of the technical advancements provided by the disclosed method, the claimed operations, as discussed above, are not routine, conventional, or well-known aspects in the art, as the claimed operations provide the aforesaid solutions to the technical problems existing in the conventional technologies. Further, the claimed operations clearly bring an improvement in the functioning of the system itself, as the claimed operations provide a technical solution to a technical problem.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of at least one example embodiment with several components in communication with each other does not imply that all such components are desired and/or required. On the contrary, a variety of optional components are described to illustrate the wide variety of possible example embodiments of the inventive concepts.

When a single device or article is described herein, it will be clear that more than one device/article (whether they cooperate or not) may be used in place of a single device/article. Similarly, where more than one device/article is described herein (whether they cooperate or not), it will be clear that a single device/article may be used in place of the more than one device/article or a different number of devices/articles may be used instead of the shown number of devices and/or programs. The functionality and/or features of a device may be alternatively embodied by one or more other devices which are not explicitly described as having such functionality/features. Thus, other example embodiments of inventive concepts need not include the device itself.

Finally, the language used herein has been principally selected for readability and instructional purposes, and it may not have been selected to delineate or circumscribe the inventive subject matter. It is therefore intended that the scope of the example embodiments of the inventive concepts be limited not by this detailed description, but rather by any claims that issue on an application based here on. Accordingly, the example embodiments of the inventive concepts are intended to be illustrative, but not limiting, of the scope of the inventive concepts, which is set forth in the following claims.

While various aspects of the example embodiments have been disclosed herein, other aspects of the example embodiments will be apparent to people of ordinary skill in the art. The various aspects and example embodiments disclosed herein are for purposes of illustration and are not intended to be limiting, with the true scope and spirit being indicated by the following claims.

We claim:

1. A method of non-volatile memory management using an Out Of Band (OOB) path, the method comprising:
monitoring, by processing circuitry associated with a host device, an available spare memory percentage of a non-volatile memory included in a storage device, the storage device communicatively connected to the host device, via the OOB path between the host device and the storage device, the OOB path being separate from an input/output (I/O) path between the host device and the storage device;
determining, by the processing circuitry, a trigger point to initiate a preemptive Garbage Collection (GC) process in the non-volatile memory based on the available spare memory percentage; and
transmitting, by the processing circuitry, via the OOB path to the storage device, a command to initiate the preemptive GC process based on the determined trigger point, the command causing the storage device to execute the preemptive GC process on the non-volatile memory upon receipt.

2. The method as claimed in claim 1, wherein a value of the trigger point for initiating the preemptive GC process is different from a value for initiating an urgent GC process.

3. The method as claimed in claim 1, wherein the command to initiate the preemptive GC process is a Vendor Unique Command.

4. A host device for non-volatile memory management using an Out Of Band (OOB) path, the host device comprising:
a memory having computer readable instructions stored thereon; and
processing circuitry configured to execute the computer readable instructions to cause the host device to,
monitor an available spare memory percentage of a non-volatile memory included in a storage device communicatively connected to the host device via the OOB path separate from an input/output (I/O) path between the host device and the storage device;
determine a trigger point to initiate a preemptive Garbage Collection (GC) process in the non-volatile memory based on the available spare memory percentage; and
transmit via the OOB path to the storage device, a command to initiate the preemptive GC process based on the determined trigger point, the command causing the storage device to execute the preemptive GC process on the non-volatile memory.

5. The host device as claimed in claim 4, wherein a value of the trigger point for initiating the preemptive GC process is different from a value for initiating an urgent GC process.

6. The host device as claimed in claim 5, wherein the command to initiate the preemptive GC process is a Vendor Unique Command.
